(19) United States
(12) Patent Application Publication
(10) Pub. No.: US 2024/0400856 A1
(43) Pub. Date: Dec. 5, 2024

(54) THERMOPLASTIC ELASTOMER POWDERS, PREPARING PROCESS THEREOF AND METHOD OF PREPARING 3D ARTICLE

(71) Applicant: BASF SE, Ludwigshafen am Rhein (DE)

(72) Inventors: Wei Zheng FAN, Shanghai (CN); Zhi Zhong CAI, Shanghai (CN); Yan Sheng LI, Shanghai (CN); Pin Lan CHEN, Shanghai (CN)

(21) Appl. No.: 18/700,742

(22) PCT Filed: Oct. 7, 2022
(86) PCT No.: PCT/EP2022/077929

§ 371 Date: Apr. 12, 2024

(30) Foreign Application Priority Data
Oct. 15, 2021 (WO) PCT/CN2021/124152

(51) Int. Cl. C09D 175/04; B29C 64/153; B29K 75/00; B33Y 10/00; B33Y 70/00; C08J 9/36

(52) U.S. Cl. CPC C09D 175/04; B29C 64/153; B33Y 10/00; B33Y 70/00; C08J 9/36; B29K 2075/00; B29K 2995/0064; B29K 2995/007; B29K 2995/0077; C08J 2375/04

(57) ABSTRACT

This disclosure relates to thermoplastic elastomer (TPE) powders, wherein the average particle size D50 of the TPE powders is in the range from 10 μm to 1 mm and at least one of average sphericity A and average sphericity B of TPE powders is no more than 0.6; to a process of preparing the TPE powders and to a method of preparing the 3D molding. The powders and the method according to the present invention allow to prepare a 3D molding with low density, high rebound resilience and good mechanical properties, especially a 3D molding comprising multiple areas having different properties.

### TECHNOLOGY FIELD

The present invention relates to the thermoplastic elastomer (TPE) powders, process of preparing the TPE powders and method of producing 3D molding.

### BACKGROUND

3D-printing technologies using thermoplastic powders, e.g., selective laser sintering (SLS), multi jet fusion (MJF) and selective heat sintering (SHS), have been used for rapid prototyping and rapid manufacturing processes. Thermoplastic powder is a class of 3D printable materials which has been widely used for footwear, protector and consumer applications. In general, the printing process prints one type of material at one printing time. Thus, it is difficult to produce 3D objects with multi-materials or multi-performance. In addition, to obtain 3D printed parts with lower density is necessary for expanding 3D printed parts from prototyping for end-use parts, especially in automotive and footwear industries. However, it is difficult to adjust and reduce density of printed parts via 3D printing process. Therefore, there is a strong need to develop a class of material and method to prepare 3D printed objects with different properties.

### SUMMARY OF THE INVENTION

One object of the present invention is to provide the thermoplastic elastomer (TPE) powders, wherein the TPE powders of the present invention can be used to produce 3D molding with low density and high rebound resilience, and 3D molding comprising multiple areas having different properties.

Another object of the present invention is to provide a process of preparing the TPE powders of the present invention.

A further object of the present invention is to provide a powder composition comprising the TPE powders of the present invention and at least one auxiliary agent.

A further object of the present invention is to provide a process of preparing the powder composition of the present invention.

A further object of the present invention is to provide a method of preparing 3D molding, which comprises using the TPE powders or powder composition of the present invention.

A further object of the present invention is to provide a 3D molding obtainable from the TPE powders or powder composition of the present invention or by the method of the present invention.

It has been surprisingly found that the above objects can be achieved by following embodiments:
1. Thermoplastic elastomer (TPE) powders, wherein the average particle size D50 of the TPE powders is in the range from 10 μm to 1 mm and at least one of average sphericity A and average sphericity B of TPE powders is no more than 0.6, wherein

Sphericity A=Surface area of volume equivalent sphere of powder/Surface area of powder, and

Sphericity B=Radius of volume equivalent sphere of powder/Radius of circumscribed sphere of powder.
2. The TPE powders according to item 1, wherein at least one of average sphericity A and average sphericity B of TPE powders is no more than 0.55, preferably no more than 0.5.
3. The TPE powders according to item 1 or 2, wherein average sphericity A of TPE powders is no more than 0.55, preferably no more than 0.5 and/or average sphericity B of TPE powders is no more than 0.5, preferably no more than 0.4.
4. The TPE powders according to any of items 1 to 3, wherein at least one of the average sphericity A and average sphericity B of TPE powders is in the range from 0.6 to 0.05, preferably from 0.55 to 0.08, or from 0.5 to 0.1.
5. The TPE powders according to any of items 1 to 4, wherein the average particle size D50 of the TPE powders is in the range from 20 to 800 μm, preferably from 30 to 600 μm.
6. The TPE powders according to any of items 1 to 5, wherein the bulk density of the TPE powders is in the range from 0.15 to 0.45 g/cm³, preferably from 0.18 to 0.35 g/cm³, more preferably from 0.18 to 0.3 g/cm³.
7. The TPE powders according to any of items 1 to 6, wherein the TPE is selected from thermoplastic polyurethane elastomer, thermoplastic co-polyester elastomer, thermoplastic polystyrene elastomer, polyether block amide, thermoplastic vulcanate, thermoplastic polyolefin, and combinations thereof, preferably selected from thermoplastic polyurethane elastomer, polyether block amide, and combination thereof.
8. A process of preparing the TPE powders according to any of items 1 to 7, which comprises pulverizing the foamed TPE material.
9. The process according to item 8, wherein the temperature of the foamed TPE material during the pulverization is lower than the Tg of the TPE material by at least 20° C., preferably by at least 40° C.
10. The process according to item 8 or 9, wherein the foamed TPE material is treated with liquid nitrogen before or during the pulverization.
11. The process according to any of items 8 to 10, wherein the average pore size of the foamed TPE material is in the range from 20 to 800 μm, preferably from 30 to 600 μm.
12. A powder composition comprising TPE powders as defined in any of items 1 to 7 and at least one auxiliary agent, preferably selected from filler, flowing agent, reinforced additive and pigment.
13. A process of preparing the powder composition according to item 12, which comprises adding the at least one auxiliary agent, preferably selected from filler, flowing agent, reinforced additive and pigment before, during and/or after the pulverization of the foamed TPE material.
14. A method of preparing 3D molding by layer-by-layer process, wherein the method comprises selectively bonding the TPE powders as defined in any of items 1 to 7 or powder composition as defined in item 12 or prepared in item 13.
15. The method according to item 14, wherein the 3D molding comprises n areas having at least one different property, wherein n is 2 or more.
16. The method according to item 15, wherein the property is selected from density, Shore A hardness and rebound resilience and combination thereof, or selected from density, Young's modulus, tensile strength, elongation at break, rebound resilience, Shore A hardness and combination thereof.
17. The method according to item 15 or 16, wherein the 3D molding comprises n areas having at least one different property and two areas of them meet at least one of following conditions:
(i) the density of said two areas differs by at least 0.05 g/cm³, preferably at least 0.1 g/cm³, more preferably at least 0.15 g/cm³, in particular at least 0.2 g/cm³;
(ii) the rebound resilience of said two areas differs by at least 0.5%, preferably at least 1%, more preferably at least 2%, in particular at least 3%;
(iii) the Shore A hardness difference between said two areas is at least 5, preferably at least 10, more preferably at least 20, in particular at least 30.
18. The method according to any of items 14 to 17, wherein the selectively bonding comprises selective laser sintering, selective inhibition of the bonding of powders, multi jet fusion, high speed sintering, 3D printing, or a microwave process.
19. The method according to any of items 15 to 18, wherein the n areas having at least one different property are formed via adjusting process parameters, preferably printing parameter, more preferably the printing parameter is selected from laser power density, scan count and printing temperature and combination thereof.
20. The method according to item 19, wherein the n areas have different densities and printing parameters meet the following conditions:
(iv) the laser power density for forming the area having higher density is higher than that for forming the area having lower density,
and/or the n areas have different rebound resilience and printing parameters meet the following condition:
(v) the laser power density for forming the area having higher rebound resilience is higher than that for forming the area having lower rebound resilience.
21. The method according to any of items 15 to 20, wherein the n areas having at least one different property are formed from the same material.
22. A 3D molding obtainable from the TPE powders according to any of items 1 to 6 or by the method according to any of items 14 to 21.
23. The 3D molding according to item 22, wherein the 3D molding includes sole, outerwear, cloth, footwear, toy, mat, tire, hose, gloves and seals.

According to the present invention, the powders and the method according to the present invention allow to prepare a 3D molding with low density, high rebound resilience and good mechanical properties, especially a 3D molding comprising multiple areas having different properties.

### DESCRIPTION OF THE DRAWING

FIG. 1 shows the pictures of expanded TPU pellet and TPU powders, wherein FIG. 1 (a) shows expanded TPU pellet and FIG. 1 (b) shows TPU powders.

FIG. 2 shows SEM images of the TPU powders.

FIG. 3 shows picture of 3D-printed part of example 3.

FIG. 4 shows SEM images of 3D-printed part of example 3.

FIG. 5 (a) shows a picture of 3D-printed part of example 4. FIG. 5 (b) shows a micrograph of part of the section of the printing part depicted in FIG. 5 (a) in according with section line A-A.

### EMBODIMENT OF THE INVENTION

The undefined article “a”, “an”, “the” means one or more of the species designated by the term following said article.

In the context of the present disclosure, any specific values mentioned for a feature (comprising the specific values mentioned in a range as the end point) can be recombined to form a new range.

One aspect of the present invention is directed to the thermoplastic elastomer (TPE) powders, wherein the average particle size D50 of the TPE powders is in the range from 10 μm to 1 mm and at least one, preferably both of average sphericity A and average sphericity B of TPE powders is no more than 0.6.

TPE Powders According to the present invention, the average particle size D50 of the TPE powders can be in the range from 10 μm to 1 mm, for example 10 μm, 20 μm, 50 μm, 80 μm, 100 μm, 150 μm, 200 μm, 250 μm, 300 μm, 350 μm, 400 μm, 500 μm, 600 μm, 700 μm, 800 μm, 900 μm or 1 mm, preferably from 10 to 800 μm, from 10 to 600 μm, from 10 to 400 μm, from 10 to 250 μm, or from 20 to 800 μm, from 20 to 600 μm, from 20 to 400 μm, from 20 to 250 μm, or from 30 to 800 μm, from 30 to 600 μm, from 30 to 400 μm, from 30 to 250 μm, or from 40 to 800 μm, from 40 to 600 μm, from 40 to 400 μm, from 40 to 250 μm, or from 50 to 800 μm, from 50 to 600 μm, from 50 to 400 μm, or from 50 to 250 μm.

The average particle size D50 can be tested according to ISO 13320-1.

According to the present invention, at least one, preferably both of the average sphericity A and average sphericity B of TPE powders is no more than 0.6. The calculation of sphericity A and sphericity B is following the equation below:

Sphericity A=Surface area of volume equivalent sphere of powder/Surface area of powder Eq.1:

Sphericity B=Radius of volume equivalent sphere of powder/Radius of circumscribed sphere of powder. Eq.2:

According to the present invention, the term “average sphericity” as used in this disclosure means number average sphericity.

According to the present invention, radius of volume equivalent sphere of powder is the radius of a sphere having volume equal to actual volume of the TPE powder.

The surface area of volume equivalent sphere of powder can be calculated as follows: 4×π×(radius of volume equivalent sphere of powder)².

With respect to the circumscribed sphere of a powder, the diameter of the circumscribed sphere of the powder is the longest dimension of the powder, i.e., the straight line distance between the two farthest points of the powder.

In an embodiment, at least one, preferably both of average sphericity A and average sphericity B of TPE powders is no more than 0.55, for example 0.5, 0.45, 0.4, 0.35 or 0.3, preferably no more than 0.5.

In an embodiment, the average sphericity A of TPE powders is no more than 0.55, preferably no more than 0.5, no more than 0.45 or no more than 0.4 and/or average sphericity B of TPE powders is no more than 0.5, preferably no more than 0.4, no more than 0.35 or no more than 0.3.

Usually, at least one, preferably both of the average sphericity A and average sphericity B of TPE powders are above 0.05, above 0.08 or above 0.1. In a preferred embodiment, at least one, preferably both of the average sphericity A and average sphericity B of TPE powders are in the range from 0.6 to 0.05, preferably from 0.55 to 0.08, or from 0.5 to 0.1, or from 0.45 to 0.1.

Sphericity of powder can be measured by Zeiss Xradia 610 Micro CT. Xray source: 50.13 (kV), 4W. Specifically, Micro CT scanning will create about 1000 slices of the sample with 0.7 μm³ voxel size. A machine learning model (random forest model) was trained to segment the slice into polymer phase and air phase. 3D local thickness calculation was applied on the polymer phase segmentation result. A threshold for 10 voxel was applied on the local thickness calculation result to generate particle volume segmentation. For each particle 3D volume (i.e., the actual volume of the powder), the surface area of powder, bound (i.e., the diameter of the circumscribed sphere of powder) were calculated by opensource Porespy package. The sphericity A and sphericity B of powders were calculated based on following equations:

Sphericity A=Surface area of volume equivalent sphere of powder/Surface area of powder Eq.1:

Sphericity B=Radius of volume equivalent sphere of powder/Radius of circumscribed sphere of powder. Eq.2:

In an embodiment, the bulk density of the TPE powders is no more than 1 g/cm³, for example 0.01 g/cm³, 0.05 g/cm³, 0.1 g/cm³, 0.15 g/cm³, 0.2 g/cm³, 0.3 g/cm³, 0.4 g/cm³, 0.5 g/cm³, 0.6 g/cm³, 0.7 g/cm³, 0.8 g/cm³, 0.9 g/cm³, or 1 g/cm³, preferably no more than 0.8 g/cm³, or no more than 0.6 g/cm³, or no more than 0.5 g/cm³. In an embodiment, the bulk density of the TPU powders can be in the range from 0.01 g/cm³ to 1 g/cm³, from 0.05 g/cm³ to 0.9 g/cm³, from 0.05 g/cm³ to 0.7 g/cm³, from 0.05 g/cm³ to 0.65 g/cm³ or from 0.1 g/cm³ to 0.6 g/cm³.

The bulk density of the TPE powders can be tested according to ISO1068.

As used herein, thermoplastic elastomer (TPE) is well known. The TPE in general use contain (i) polymeric blocks (usually referred to as “hard” blocks or A blocks) and (ii) amorphous polymeric blocks (usually referred to as “soft” blocks or B blocks). Each soft block is linked to at least two hard blocks. Melting or softening of the hard blocks permits viscous flow of the polymeric chains, resulting in thermoplastic behavior.

The TPE can be selected from thermoplastic polyurethane elastomer (TPU), thermoplastic co-polyester elastomer (TPC), thermoplastic styrene elastomer (TPS), polyether block amide (PBA), thermoplastic vulcanite (TPV), thermoplastic polyolefin (TPO), and combinations thereof, preferably selected from thermoplastic polyurethane elastomer (TPU), polyether block amide (PBA), and combination thereof.

### Thermoplastic Polyurethane Elastomer (TPU):

TPUs and processes for their production are well known. By way of example, TPUs can be produced via reaction of (a) isocyanates with (b) compounds reactive toward isocyanates and having a molar mass of from 500 to 10000 and, if appropriate, (c) chain extenders having a molar mass of from 50 to 499, if appropriate in the presence of (d) catalysts and/or of (e) conventional auxiliaries and/or conventional additives.

The components (a) isocyanate, (b) compounds which are reactive toward isocyanates, (c) chain extenders are referred to individually or collectively as formative components. The formative components including the catalyst and/or the customary auxiliaries and/or additives are also referred to as starting materials.

To adjust hardening and melt index of the TPU, the molar ratios of the amounts of the formative components (b) and (c) used can be varied.

To produce softer thermoplastic polyurethanes, e.g. polyurethanes having a Shore A hardness of less than 95, preferably from 70 to 95 Shore A, preference is given to using the essentially bifunctional polyols (b) also referred to as polyhydroxyl compounds (b) and the chain extenders (c) in molar ratios of advantageously from 1:1 to 1:5, preferably from 1:1.5 to 1:4.5, so that the resulting mixtures of the formative components (b) and (c) have a hydroxyl equivalent weight greater than 200, in particular from 230 to 450, while to produce harder TPU, e.g. TPU having a Shore A hardness of greater than 98, preferably from 55 Shore D to 75 Shore D, the molar ratios of (b):(c) are in the range from 1:5.5 to 1:15, preferably from 1:6 to 1:12, so that the resulting mixtures of (b) and (c) have a hydroxyl equivalent weight of from 110 to 200, preferably from 120 to 180.

To prepare the TPU, the formative components (a), (b) and in a preferred embodiment also (c) are reacted, preferably in the presence of a catalyst (d) and optionally auxiliaries and/or additives (e) in such amounts that the equivalence ratio of NCO groups of the diisocyanates (a) to the sum of the isocyanate-reactive groups of the components (b) and (c) is 0.95 to 1.10:1, preferably 0.98 to 1.08:1 and in particular 1.0 to 1.05:1.

According to the invention, preference is given to preparing TPU in which the TPU has a weight average molecular weight of at least 0.1×10⁶ g/mol, preferably at least 0.4×10⁶ g/mol and in particular greater than 0.6×10⁶ g/mol. The upper limit to the weight average molecular weight of the TPU is generally determined by the processability and also the desired property spectrum. The number average molecular weight of the TPU is preferably not more than 0.8×10⁶ g/mol. The average molecular weights indicated above for the TPU and also for the formative components (a) and (b) can be determined by means of gel permeation chromatography.

As organic isocyanates (a), preference is given to using aliphatic, cycloaliphatic, araliphatic and/or aromatic isocyanates, more preferably trimethylene, tetramethylene, pentamethylene, hexamethylene, heptamethylene and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4-bis(isocyanatomethyl)cyclohexane and/or 1,3-bis(isocyanatomethyl)cyclohexane (HXDI), paraphenylene 2,4-diisocyanate (PPDI), tetramethylenexylene 2,4-diisocyanate (TMXDI), dicyclohexylmethane 4,4′-, 2,4′- and 2,2′-diisocyanate (H12 MDI) hexamethylene 1,6-diisocyanate (HDI), cyclohexane 1,4-diisocyanate, 1-methycyclohexane 2,4- and/or 2,6-diisocyanate, diphenylmethane 2,2′-, 2,4′- and/or 4,4′-diisocyanate (MDI), naphthylene 1,5-diisocyanate (NDI), tolylene 2,4- and/or 2,6-diisocyanate (TDI), diphenylmethane diisocyanate, 3,3′-dimethylbiphenyl diisocyanate, diphenylmethane 1,2-diisocyanate and/or phenylene diisocyanate.

Preference is given to using the isocyanates diphenylmethane 2,2′-, 2,4′- and/or 4,4′-diisocyanate (MDI), hexamethylene 1,6-diisocyanate (HDI) and dicyclohexylmethane 4,4′-, 2,4′- and 2,2′-diisocyanate (H12 MDI), with particular preference being given to diphenylmethane 4,4′-diisocyanate (4,4′-MDI).

As compounds (b) which are reactive toward isocyanates, preference is given to those having a molecular weight in the range from 500 g/mol to 8×10³ g/mol, preferably from 0.7×10³ g/mol to 6.0×10³ g/mol, in particular from 0.8×10³ g/mol to 4.0×10³ g/mol.

The compound (b) which is reactive toward isocyanate has on statistical average at least 1.8 and not more than 3.0 Zerewitinoff-active hydrogen atoms; this number is also referred to as functionality of the compound (b) which is reactive toward isocyanate and gives the theoretical molar amount, calculated for one molecule, of the isocyanate-reactive groups of the molecule. The functionality is preferably in the range from 1.8 to 2.6, more preferably in the range from 1.9 to 2.2 and in particular 2.

The compound which is reactive toward isocyanate is substantially linear and is one substance which is reactive toward isocyanate or a mixture of various substances, with the mixture then satisfying the requirement mentioned.

These long-chain compounds are used in a molar proportion of from 1 equivalent mol % to 80 equivalent mol %, based on the isocyanate group content of the polyisocyanate.

The compound (b) which is reactive toward isocyanate preferably has a reactive group selected from a hydroxyl group, an amino group, a mercapto group or a carboxyl group. Preference is given to a hydroxyl group. The compound (b) which is reactive toward isocyanate is particularly preferably selected from the group consisting of polyesterols, polyetherols and polycarbonate diols, which are also summarized under the term “polyols”.

Preference is also given to polyester diols, preferably polycaprolactone, and/or polyether polyols, preferably polyether diols, more preferably those based on ethylene oxide, propylene oxide and/or butylene oxide, preferably polypropylene glycol. One particularly preferred polyether is polytetrahydrofuran (PTHF), in particular polyetherols.

Particular preference is given to polyols selected from the following group: copolyesters based on adipic acid, succinic acid, pentanedioic acid, sebacic acid or mixtures thereof and mixtures of 1,2-ethanediol and 1,4-butanediol, copolyesters based on adipic acid, succinic acid, pentanedioic acid, sebacic acid or mixtures thereof and mixtures of 1,4-butanediol and 1,6-hexanediol, polyesters based on adipic acid, succinic acid, pentanedioic acid, sebacic acid or mixtures thereof and 3-methylpentane-1,5-diol and/or polytetramethylene glycol (polytetrahydrofuran, PTHF).

Particular preference is given to using the copolyester based on adipic acid and mixtures of 1,2-ethanediol and 1,4-butanediol or the copolyester based on adipic acid and 1,4-butanediol and 1,6-hexanediol or the polyester based on adipic acid and polytetramethylene glycol (polytetrahydrofuran PTHF) or a mixture thereof.

Very particularly preference is given to using a polyester based on adipic acid and polytetramethylene glycol (PTHF) or mixtures thereof as polyol.

In preferred embodiments, use is made of chain extenders (c); these are preferably aliphatic, araliphatic, aromatic and/or cycloaliphatic compounds which have a molecular weight of from 50 g/mol to 499 g/mol and preferably have 2 isocyanate-reactive groups, also referred to as functional groups.

The chain extender (c) is preferably at least one chain extender selected from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, dipropylene glycol, 1,4-cyclohexanediol, 1,4-dimethanolcyclohexane and neopentyl glycol. Chain extenders selected from the group consisting of 1,2-ethylene glycol, 1,3-propanediol, 1,4-butanediol and 1,6-hexanediol are particularly suitable.

Very particularly preferred chain extenders are 1,4-butanediol, 1,6-hexanediol and ethanediol.

In preferred embodiments, catalysts (d) are used together with the formative components. These are, in particular, catalysts which accelerate the reaction between the NCO groups of the isocyanates (a) and the hydroxyl groups of the compound (b) which is reactive toward isocyanates and, if used, the chain extender (c). Preferred catalysts are tertiary amines, in particular triethylamine, dimethylcyclohexylamine, N-methylmorpholine, N,N′-dimethylpiperazine, 2-(dimethylaminoethoxy) ethanol, diazabicyclo[2.2.2]octane. In another preferred embodiment, the catalysts are organic metal compounds such as titanic esters, iron compounds, preferably iron (III) acetylacetonate, tin compounds, preferably those of carboxylic acids, particularly preferably tin diacetate, tin dioctoate, tin dilaurate or dialkyltin salts, more preferably dibutyltin diacetate, dibutyltin dilaurate, or bismuth salts of carboxylic acids, preferably bismuth decanoate.

Particularly preferred catalysts are tin dioctoate, bismuth decanoate, titanic esters. The catalyst (d) is preferably used in amounts of from 0.0001 to 0.1 part by weight, from 0.001 to 0.05 part by weight per 100 parts by weight of the isocyanate-reactive compound (b).

Apart from catalysts (d), customary auxiliaries (e) can also be added to the formative components (a) to (c). Mention may be made by way of example of surface-active substances, fillers, flame retardants, nucleating agents, oxidation inhibitors, lubricants and mold release agents, dyes and pigments, optionally stabilizers, preferably against hydrolysis, light, heat or discoloration, inorganic and/or organic fillers, reinforcing materials and/or plasticizers.

### Thermoplastic Polyester Elastomers:

TPE may alternatively be a thermoplastic polyester elastomer, also known as a TPC. Thermoplastic polyester elastomer comprises polyesters segments and polyether segments. The polyesters segments can be produced by the reaction of dicarboxylic acid and derivative thereof (such as terephthalate) and diols (such as butanediol). The polyether segments can comprise polyalkylene (ether) glycol or polyol.

The polyester segments can comprise polybutylene terephthalate (PBT). In an embodiment, the polyester segments have a segment molecular of 3000 Daltons to 9000 Daltons. In an embodiment, the polyester segments have a segment molecular of 5000 Daltons to 7000 Daltons.

The polyether segments comprise long-chain polyols. In an embodiment, the polyether segments comprise polyethylene glycol (PEG), polypropylene glycol (PPG) or polypropylene ether glycol (PPEG), polytetramethylene glycol (PTMG or PTHF) polytetramethylene ether glycol, and combinations thereof. In an embodiment, the polyether segments have a segment molecular of 200 Daltons to 4000 Daltons. In an embodiment, the polyether segments have a segment molecular of 1000 Daltons to 3000 Daltons.

In an embodiment, the thermoplastic polyester elastomer comprises a polytetramethylene ether terephthalate soft segment and a polybutylene terephthalate hard segment. Thermoplastic polyester elastomers are commercially available, and non-limiting examples are available under the tradenames HYTREL (DuPont Company, Wilmington, Del.), ARNITEL (DSM Engineering Plastics, Evansville, Ind.), and PELPRENE (Toyobo Co., Ltd., Osaka, Japan).

### Thermoplastic Polystyrene Elastomers:

TPE may alternatively be a thermoplastic polystyrene elastomer, also known as TPS. Thermoplastic polystyrene elastomers are typically based on A-B-A type block structure where A is a hard phase and B is an elastomer. Usually, the thermoplastic polystyrene elastomer comprises ethylene, propylene, butadiene, isoprene units or combination thereof. In an embodiment, the thermoplastic polystyrene elastomer is a styrene ethylene butylene styrene block copolymer. In an embodiment, the thermoplastic polystyrene elastomer is a poly(styrene-butadiene-styrene), a poly(styrene-ethylene-co-butylene-styrene), a poly(styrene-isoprene-styrene), any copolymer thereof, and any blend thereof. Non-limiting examples of thermoplastic polystyrene elastomers are Kraton D and Kraton G.

### Thermoplastic Vulcanizate Elastomers:

TPE may alternatively be a thermoplastic vulcanate elastomer, also known as a TPV. A non-limiting example of a thermoplastic vulcanate elastomer is Santoprene from ExxonMobil.

### Polyether Block Amides:

The thermoplastic elastomer may alternatively be a polyether block amide, also known as a PBA. Suitable PBA may be obtained by copolymerization of a cyclic lactam with a dicarboxylic acid and a diamine to prepare a carboxylic acid-functional polyamide block, followed by reaction with a polyether diol (polyoxyalkylene glycol).

Cyclic lactam can comprise-caprolactam, pyrrolidone or w-laurolactam or combination thereof.

Dicarboxylic acid can comprise aromatic dicarboxylic acids including, for example, phthalic acid, iso- and terephthalic acid or esters thereof; aliphatic dicarboxylic acids including, for example, cyclohexane-1,4-dicarboxylic acid, adipic acid, sebacic acid, azelaic acid and decanedicarboxylic acid as saturated dicarboxylic acids, and maleic acid, fumaric acid, aconitic acid, itaconic acid, tetrahydrophthalic acid and tetrahydroterephthalic acid as unsaturated aliphatic dicarboxylic acids.

Diamine can have the general formula H₂N—R″—NH₂ where R″ may be aromatic and aliphatic. R″ may have 2 to 30, preferably 2 to 20 or 2 to 16 carbon atoms. Diamine can comprise ethylenediamine, tetramethylenediamine, pentamethylenediamine, hexamethylenediamine, or decamethylenediamine, 1,4-cyclohexanediamine, m-xylylenediamine and combination thereof.

Polyether diol can comprise polyethylene glycol (PEG), polypropylene glycol (PPG) or polypropylene ether glycol (PPEG), polytetramethylene glycol (PTMG or PTHF), polytetramethylene ether glycol, and combinations thereof. Polymerization may be carried out, for example, at temperatures of from 180° C. to 300° C. A non-limiting example of a polyether block amide is Vestamid E from Evonik.

### Thermoplastic Polyolefin Elastomers:

The thermoplastic elastomer may alternatively be a thermoplastic polyolefin elastomer, also known as a TPO. A non-limiting example of a thermoplastic polyolefin elastomer is Engage from Dow.

### Process of Preparing the TPE Powders

In a further aspect, the invention relates to a process of preparing the TPE powders according to the present invention, which comprises pulverizing the foamed TPE material.

According to a preferred embodiment, the temperature of the foamed TPE material during the pulverization is lower than the Tg of the TPE material by at least 20° C. (for example 20° C., 40° C., 60° C., 80° C., or 100° C.), preferably by at least 40° C. or by at least 60° C.

In an embodiment, the foamed TPE material is treated with liquid nitrogen before or during the pulverization. A person skilled in the art can determine the time for treating the foamed TPE material by liquid nitrogen as long as the foamed TPE material is sufficiently cooled.

According to the present invention, the process can further comprise sieving the pulverized material. The TPE powders with the target particle size can be obtained via sieving.

According to the present invention, the foamed TPE material can be crushed before pulverization to obtain small particles having average particle size less than 10 cm, preferably less than 5 cm.

According to the present invention, the TPE powders are derived from the foamed TPE material. TPEs are those as described above.

To effect foaming, it is possible to use blowing agents. Suitable blowing agents are, for example, low-boiling liquids. Liquids which are inert toward the organic polyisocyanate and preferably have a boiling point below 200° C. are suitable.

Examples of such liquids which are preferably used are halogenated, preferably fluorinated, hydrocarbons such as methylenechloride and dichloromonofluoromethane, perfluorinated or partially fluorinated hydrocarbons, preferably trifluoromethane, difluoromethane, difluoroethane, tetrafluoroethane and heptafluoropropane, hydrocarbons, preferably n-butane and isobutane, n-pentane and isopentane and also the industrial mixtures of these hydrocarbons, propane, propylene, hexane, heptane, cyclobutane, cyclopentane and cyclohexane, dialkyl ethers, preferably dimethyl ether, diethyl ether and furan, carboxylic esters, preferably methyl and ethyl formate, ketones, preferably acetone, and/or fluorinated and/or perfluorinated, tertiary alkylamines, preferably perfluorodimethylisopropylamine. Mixtures of these low-boiling liquids with one another and/or with other substituted or unsubstituted hydrocarbons can also be used.

In general, amounts of blowing agent can be in the range of from 1% by weight to 15% by weight, preferably from 2% by weight to 11% by weight, based on the total weight of the TPE.

Depending on their inertness toward the starting materials, the liquid blowing agents can be incorporated as early as in the preparation of the TPE, especially TPU. However, in order for the TPE not to be expanded immediately, a counter pressure has to be applied until the TPE has become solid and thus holds the blowing agent.

In another preferred embodiment, the finished TPE is brought into contact with the blowing agent.

In principle, the foamed TPE material can be produced via suspension or extrusion processes directly or indirectly by way of expandable TPE material and foaming in a pressure prefoamer with steam or hot air.

In the suspension process, the TPE in the form of pellets is heated with water, with a suspending agent, and with the blowing agent in a closed reactor to above the softening point of the pellets. The polymer pellets are thereby impregnated by the blowing agent. It is then possible either to cool the hot suspension, whereupon the particles solidify with inclusion of the blowing agent, and to depressurize the reactor. The (expandable) microspheres comprising blowing agent and obtained in this way are foamed via heating to give the expanded microspheres. As an alternative, it is possible to depressurize the hot suspension suddenly, without cooling (explosion-expansion process), whereupon the softened microspheres comprising blowing agent immediately foam to give the expanded microspheres.

In the extrusion process, the TPE is mixed, with melting, in an extruder with a blowing agent which is introduced into the extruder. Either the mixture comprising blowing agent is extruded and pelletized under conditions of pressure and temperature such that the TPE pellets do not foam (expand), an example of a method being used for this purpose being underwater pelletization, which is operated with a water pressure of more than 2 bar. This gives expandable microspheres comprising blowing agent, which are then foamed via subsequent heating to give the expanded microspheres. Or the mixture can also be extruded and pelletized at atmospheric pressure. In this process, the melt extrudate foams and the product obtained via pelletization is the expanded microspheres.

The TPE can be used in the form of commercially available pellets, powder, granules, or in any other form. It is advantageous to use pellets. An example of a suitable form is what are known as minipellets whose preferred average diameter is from 0.2 to 10 mm, in particular from 0.5 to 5 mm. These mostly cylindrical or round minipellets are produced via extrusion of the TPE and, if appropriate, of other additives, discharged from the extruder, and if appropriate cooling, and pelletization. In the case of cylindrical minipellets, the length is preferably from 0.2 to 10 mm, in particular from 0.5 to 5 mm. The pellets can also have a lamellar shape. The average diameter of the thermoplastic polyurethane comprising blowing agent is preferably from 0.2 to 10 mm.

As a function of the process used, the preferred blowing agents can vary if appropriate. In the case of the suspension process, the blowing agent used preferably comprises organic liquids or inorganic gases, or a mixture thereof. Liquids that can be used comprise halogenated hydrocarbons, but preference is given to saturated, aliphatic hydrocarbons, in particular those having from 3 to 8 carbon atoms. Suitable inorganic gases are nitrogen, air, ammonia, or carbon dioxide.

In production via an extrusion process, the blowing agent used preferably comprises volatile organic compounds whose boiling point at atmospheric pressure of 1013 mbar is from −25 to 150° C., in particular from −10 to 125° C. Hydrocarbons (preferably halogen-free) have good suit-ability, in particular C₄₋₁₀-alkanes, for example the isomers of butane, of pentane, of hexane, of heptane, and of octane, particularly preferably sec-pentane. Other suitable blowing agents are bulkier compounds, examples being alcohols, ketones, esters, ethers, and organic carbonates.

It is also possible to use halogenated hydrocarbons, but the blowing agent is preferably halogen-free. Very small proportions of halogen-containing blowing agents in the blowing agent mixture are however not to be excluded. It is, of course, also possible to use mixtures of the blowing agents mentioned.

The amount of blowing agent is preferably from 0.1 to 40 parts by weight, in particular from 0.5 to 35 parts by weight, and particularly preferably from 1 to 30 parts by weight, based on 100 parts by weight of TPE used.

If the expandable TPE microspheres are obtained, these can be foamed in a known manner to obtain the expanded TPE microspheres. The foaming generally takes place via heating of the expandable microspheres in conventional foaming apparatuses, e.g., with hot air or superheated steam in what is known as a pressure prefoamer, for example of the type usually used for processing of expandable polystyrene (EPS). It is preferable to foam the microspheres at a temperature at which they soften (softening range), particularly preferably at temperatures of from 100 to 140° C.

The average diameters of the expanded TPE microspheres are usually in the range from 0.2 to 20 mm, preferably from 0.5 to 15 mm, and in particular from 1 to 12 mm. In the case of non-spherical, e.g., elongate or cylindrical, microspheres, diameter means the longest dimension.

In an embodiment, the foamed TPE material is an expanded TPE microsphere or pellet.

In an embodiment, the TPE material is foamed with the supercritical fluid. The foaming with supercritical fluid can be carried out by following steps:
(i) treating the TPE material with the supercritical fluid at a foaming temperature, and
(ii) foaming the treated TPE material obtained in step (i) to produce a foamed TPE material.

The supercritical fluid can be selected from carbon dioxide, water, C₁-C₆-alkane, ethylene, propylene, methanol, ethanol, acetone, nitrogen, or a combination thereof, preferably carbon dioxide.

In an embodiment, the average pore size of the foamed TPE material is in the range from 20 to 800 μm (for example 20 μm, 30 μm, 50 μm, 80 μm, 100 μm, 150 μm, 200 μm, 300 μm, 500 μm, 600 μm, or 800 μm), preferably from 30 to 600 μm or from 40 to 500 μm.

### Method of Producing 3D Molding

In a further aspect, the invention relates to a method of producing 3D molding by layer-by-layer process, wherein the method comprises selectively bonding the TPE powders of the present invention.

In a preferred embodiment, the 3D molding comprises n areas having at least one different property, wherein n is 2 or more, for example 2, 3, 4, 5, 6, 8, 10, 20, 30 or 50, preferably in the range from 2 to 50, from 2 to 30, from 2 to 10, or from 2 to 5. The process according to the present invention allows to prepare the 3D molding comprising multiple areas having at least one different property.

In an embodiment, the property is selected from density, Young's modulus, tensile strength, elongation at break, rebound resilience, Shore A hardness and combination thereof, or selected from density, Shore A hardness and rebound resilience and combination thereof.

The tensile strength, elongation at break and Young's modulus can be measured according to ISO527-21/A 15 2012.

The density can be tested according to ASTM D792.

In an embodiment, the 3D molding comprises n areas having at least one different property and two areas of them meet at least one of following conditions:
(i) the density of said two areas differs by at least 0.05 g/cm³ (for example 0.1 g/cm³, 0.15 g/cm³, 0.2 g/cm³, 0.3 g/cm³, 0.4 g/cm³, 0.5 g/cm³, 0.6 g/cm³, 0.7 g/cm³, or 0.8 g/cm³), preferably at least 0.1 g/cm³, more preferably at least 0.15 g/cm³, in particular at least 0.2 g/cm³;
(ii) the rebound resilience of said two areas differs by at least 0.5% (for example 0.5%, 1%, 1.5%, 2%, 2.5%, 3%, 4%, 5%, 6%, 7%, 8%, 9% or 10%), preferably at least 1%, more preferably at least 2%, in particular at least 3%;
(iii) the Shore A hardness difference between said two areas is at least 5 (for example 10, 15, 20, 30, 40, 50, 60, 70), preferably at least 10, more preferably at least 20, in particular at least 30.

In an embodiment, the density (condition i) of said two areas differs by from 0.05 to 0.8 g/cm³, preferably from 0.1 to 0.7 g/cm³, more preferably from 0.15 to 0.6 g/cm³ or from 0.15 to 0.5 g/cm³.

In an embodiment, the rebound resilience (condition ii) of said two areas differs by from 0.5% to 10%, preferably from 1% to 9%, more preferably from 1.5% to 8% or from 2% to 7%. According to the present invention, the rebound resilience can be tested according to ASTM D2632.

In an embodiment, the Shore A hardness difference between said two areas is from 5 to 70, preferably from 10 to 60 or from 15 to 50. According to the present invention, hardness (Shore A) can be tested according to ASTM D2240-15.

In an embodiment, said two areas meet condition (ii), preferably conditions (ii) and (i), more preferably conditions (ii), (i) and (iii).

In an embodiment, the 3D molding comprises n areas having different densities and the densities of n areas are sequentially increased. In an embodiment, the density is sequentially increased by at least 0.05 g/cm³, preferably at least 0.08 g/cm³, more preferably at least 0.1 g/cm³ from the first area to the nth area.

In the method of the present invention, the selectively bonding comprises selective laser sintering, selective inhibition of the bonding of powders, multi jet fusion, high speed sintering, 3D printing, or a microwave process, preferably 3D printing.

In an embodiment, the n areas having at least one different property are formed via adjusting process parameters, preferably printing parameter such as those in 3D printing, more preferably the printing parameter is selected from laser power density, scan count and printing temperature and combination thereof.

In an embodiment, the n areas of the 3D molding have different densities and printing parameters meet the following condition:
(iv) the laser power density for forming the area having higher density is higher than that for forming the area having lower density.

In an embodiment, the n areas of the 3D molding have different rebound resilience and printing parameters meet the following condition:
(v) the laser power density for forming the area having higher rebound resilience is higher than that for forming the area having lower rebound resilience.

In an embodiment, the n areas of the 3D molding have different densities and printing parameters meet the condition (iv); and/or the n areas of the 3D molding have different rebound resilience and printing parameters meet condition (v).

In a preferred embodiment, the n areas having at least one different property are formed from the same material, i.e., the composition of the material used to form the n areas is the same. The method according to the present invention allows to prepare a 3D molding with low density, high rebound resilience and good mechanical properties, especially a 3D molding comprising multiple areas having different properties by using the same material.

In an embodiment, the TPE powder is used in together with at least one auxiliary agent. The auxiliary can be selected from filler, flowing agent, reinforced additive and pigment. Details of the auxiliary are as described below.

### Powder Composition

A further aspect of the present invention relates to a powder composition comprising the TPE powders according to the present invention and at least one auxiliary agent. The auxiliary agent can be selected from filler, flowing agent, reinforced additive and pigment.

A further aspect of the present invention relates to a process of preparing the powder composition according to the present invention, which comprises adding the at least one auxiliary agent before, during and/or after the pulverization of the foamed TPE material.

The flowing agent can be selected from the group consisting of silica, fumed silica, precipitated silica, colloidal silica, hydrophobic silica and mixtures of thereof.

The hydrophobic silica is preferably obtained by reacting silica with a hydrophobicizer. The hydrophobicization preferably takes place after precipitation or pyrolysis of the silica, and via substantial reaction of free OH groups of the silica with, for example, silanes, silazanes, or siloxanes. Preferred hydrophobicizers are hexadecylsilane, dimethyldichlorosilane, hexamethyldisilazane, octamethylcylcotetrasiloxane, polydimethylsiloxane or methacrylic silanes.

The flowing agent of the invention has a median particle size of from 5 nm to 200 μm. The preferred median particle size of the flowing agent is from 10 nm to 150 μm, particularly preferably from 100 nm to 100 μm.

The flowing agent has a specific surface area of from 20 to 600 m²/g. The flowing agent preferably has a specific surface area of from 40 to 550 m²/g, particularly preferably from 60 to 500 m²/g, and more preferably from 60 to 450 m²/g.

The amount of the flowing agent in the composition can be from 0 to 5% by weight, 0.01 to 5% by weight, from 0.01 to 3% by weight, from 0.01 to 2% by weight, from 0.05 to 5% by weight, from 0.05 to 3% by weight, from 0.05 to 2% by weight, from 0.1 to 5% by weight, from 0.1 to 3% by weight, or from 0.1 to 2% by weight, based on the total weight of the composition.

Examples of fillers and reinforcing additives can include glass microsphere, glass fiber and carbon fiber.

As other auxiliary agents, mention may be made by way of preferred example of surface-active substances, nucleating agents, lubricant wax, dyes, catalyst, UV absorbers and stabilizers, e.g. against oxidation, hydrolysis, light, heat or discoloration. As hydrolysis inhibitors, preference is given to oligomeric and/or polymeric aliphatic or aromatic carbodiimides. To stabilize 3D-printed objects of the invention against aging and damaging environmental influences, stabilizers are added to system in preferred embodiments.

If the composition of the invention is exposed to thermo-oxidative damage during use, in preferred embodiments antioxidants are added. Preference is given to phenolic antioxidants. Phenolic antioxidants such as Irganox® 1010 from BASF SE are given in Plastics Additive Handbook, 5th edition, H. Zweifel, ed., Hanser Publishers, Munich, 2001, pages 98-107, page 116 and page 121.

If the composition of the invention is exposed to UV light, it is preferably additionally stabilized with a UV absorber. UV absorbers are generally known as molecules which absorb high-energy UV light and dissipate energy. Customary UV absorbers which are employed in industry belong, for example, to the group of cinnamic esters, diphenylcyan acrylates, formamidines, benzylidenemalonates, diarylbutadienes, triazines and benzotriazoles. Examples of commercial UV absorbers may be found in Plastics Additive Handbook, 5th edition, H. Zweifel, ed, Hanser Publishers, Munich, 2001, pages 116-122.

Further details regarding the abovementioned auxiliaries may be found in the specialist literature, e.g., in Plastics Additive Handbook, 5th edition, H. Zweifel, ed, Hanser Publishers, Munich, 2001.

The total amount of at least one auxiliary can be in the range from 0 to 60 wt. %, preferably from 0 to 40 wt. %, from 0 to 20 wt. %, from 0 to 10 wt. %, from 0 to 5 wt. %, or from 0.01 to 60 wt. %, 0.05 to 40 wt. %, 0.1 to 20 wt. %, based on the total weight of the composition.

3D molding

In a further aspect, the invention relates to a 3D molding obtainable from the TPE powders of the present invention or by the method of the present invention.

According to an embodiment, the 3D molding includes sole, outerwear, cloth, footwear, toy, mat, tire, hose, gloves and seals.

The 3D molding of the present invention has low density, high rebound resilience and good mechanical properties.

In a preferred embodiment, the 3D molding comprises n areas having at least one different property, wherein n is 2 or more. Details of such 3D molding can refer to the above description for the method of preparing the 3D molding.

In a preferred embodiment, the n areas having at least one different property are formed from the same material.

### EXAMPLES

### Materials

Expanded TPU 130U pellet from BASF: BASF commercial product: Infinergy X1125-130 U, bulk Density of the pellet is 0.12-0.14 g/cm³, average pellet weight is 26 mg and average pore size is 130 μm.
TPU 88A: Ultrasint TPU 88A powders for 3D printing from BASF. The TPU 88A powders were prepared by grinding of TPU pellets. Bulk density of TPU 88A: 0.6 g/cm³, average particle size D50 of TPU 88A: 80 μm. The average sphericity A of Ultrasint TPU 88A powders is 0.67 and the average sphericity B of Ultrasint TPU 88A powders is 0.68.
Flowing agent: HDKN20 amorphous silica from Wacker (BET: 175-225 m²/g).

### Methods

All samples (printed-parts) were printed by Farsoon HT251 SLS 3D printer.
Tensile strength and elongation at break were measured at a rate of 6 mm/min (according to ISO527-21/A 15 2012) by Zwick Z050.
Rebound resilience was tested according to ASTM D2632.
Hardness was determined in accordance with ASTM D2240-15 with ASKER DUROMETER (TYPE A).
The bulk density of the TPU powders was tested according to ISO1068.
Density was investigated according to ASTM D792.
The average particle size D50 of powders was tested according to ISO 13320-1 by Beckerman Coulter LS 13 320 Lase Diffraction Particle Size Analyzer.
The 3D morphology information of powder was measured by Zeiss Xradia 610 Micro CT. Xray source: 50.13 (kV), 4W. Specifically, Micro CT scanning will create about 1000 slices of the sample with 0.7 μm³ voxel size. A machine learning model (random forest model) was trained to segment the slice into polymer phase and air phase. 3D local thickness calculation was applied on the polymer phase segmentation result. A threshold for 10 voxel was applied on the local thickness calculation result to generate particle volume segmentation. For each particle 3D volume (i.e., the actual volume of the powder), the surface area of powder, bound (i.e., the diameter of the circumscribed sphere of powder) were calculated by opensource Porespy package. The sphericity A and sphericity B of powders were calculated based on following equations:

$$Sphericity A = Source area of volume equivalent sphere of powder / Surface area of powder \qquad Eq . 1$$

$$Sphericity B = Radius of volume equivalent sphere of powder / Radius of circumscribed sphere of powder . \qquad Eq . 2$$

### Example 1: Preparing the TPU Powders

The TPU powders were prepared by grinding of expanded TPU 130U pellet. The TPU Powders were prepared by cryogenic grinding under −196° C., grinding speed 100 m/s (linear velocity) and sieved to required size. The average particle size D50 of the powders is 160 μm, the bulk density of the powders is 0.18 g/cm³.

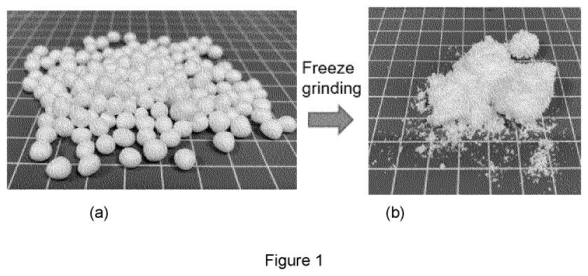

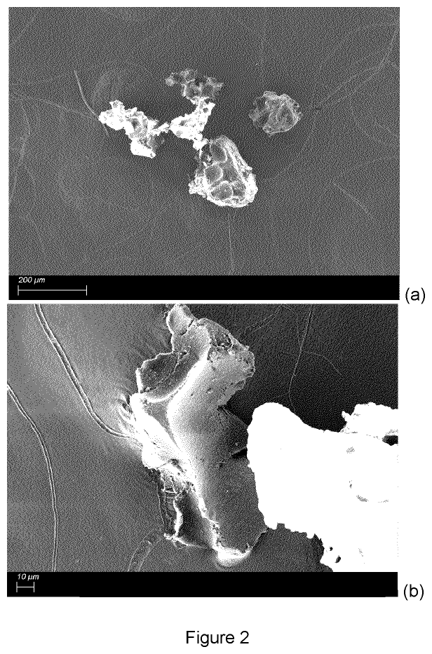

The pictures of expanded TPU pellets and the resulted TPU powders were shown in FIG. 1 (a) and FIG. 1 (b), respectively. SEM images of the TPU powders were show in FIG. 2. As can be seen from the SEM images, the TPU powders had uneven surface. The average sphericity A of TPU powders was 0.33. The average sphericity B of TPU powders was 0.17.

### Examples 2a, 2b, 2c, 2d

The TPU powders obtained in example 1 were used in examples 2a, 2b, 2c and 2d. The powder compositions in examples 2a to 2d were prepared by blending the powders of the components as shown in table 1. The blending experiments were carried out on the HTS-5 High speed mixer from Dongguan Huanxin Machinery Co., Ltd. The powders were mixed under 1400 rpm for 60 seconds to obtain the powder composition.

The resulted powder compositions were printed by HT251 Selective Laser Sintering 3D printer which was manufactured from Farsoon. For a typical printing process, the powder compositions were loaded in the feed chamber of the printer. Detailed printing parameters were listed in table 2.

Post-treatment process: Once the printing process was completed and the printed parts were cooled, the build chamber was removed from the printer and transferred to a cleaning station, the printed parts were separated from the excess powders to obtain the final 3D-printed parts.

Tensile strength, elongation at break, hardness, rebound resilience and density of the printed parts were also summarized in table 1.

TABLE 1

| Example | 2a | 2b | 2c | 2d |
|---|---|---|---|---|
| TPU powders (wt. %) | 99.5 | 99.5 | 99.5 | 99.5 |
| N20 wt (wt. %) | 0.5 | 0.5 | 0.5 | 0.5 |
| Tensile strength (MPa) | 0.4 | 0.9 | 2.8 | 5.3 |
| Elongation at break (%) | 122 | 148 | 220 | 390 |
| Hardness (Shore A) | 10 | 29 | 50 | 73 |
| Rebound resilience (%) | 51 | 52 | 56 | 46 |
| Density (g/cm³) | 0.373 | 0.485 | 0.663 | 0.955 |

As can be seen, the powders according to the present invention allow to prepare 3D-printed part with low density and high rebound resilience and good mechanical properties. In addition, the properties of the 3D-printed part can be easily adjusted via changing the printing parameters as shown in table 2 below.

TABLE 2
Printing parameters

| Example | 2a | 2b | 2c | 2d |
|---|---|---|---|---|
| Part bed T (° C.) | 65 | 65 | 65 | 65 |
| Feed T (° C.) | 40 | 40 | 40 | 40 |
| Piston T (° C.) | 50 | 50 | 50 | 50 |
| Cylinder T (° C.) | 50 | 50 | 50 | 50 |
| Laser power density (mJ/mm²) | 23 | 55 | 59 | 72 |
| Scan count | 6 | 3 | 2 | 6 |
| Layer thickness (μm) | 180 | 180 | 180 | 180 |
| Roller speed (mm/s) | 7.62 | 7.62 | 7.62 | 7.62 |

### Example 3: 3D-Printed Parts with Multiple Areas

In Example 3, 3D-printed part with multiple areas, i.e., upper layer and lower layer was prepared. The TPU powders obtained in example 1 were used in example 3. The powder composition in example 3 was prepared by blending the powders of the components as shown in table 3. The blending experiment was carried out on the HTS-5 High speed mixer from Dongguan Huanxin Machinery Co., Ltd. The powders were mixed under 1400 rpm for 60 seconds to obtain the powder composition.

The resulted powder composition was printed by HT251 Selective Laser Sintering 3D printer to prepare the 3D-printed part with upper layer and lower layer. For a typical printing process, the powder composition was loaded in the feed chamber of the printer. Detailed printing parameters were listed in the table 3.

Post-treatment process: Once the printing process was completed and the printed part was cooled, the build chamber was removed from the printer and transferred to a cleaning station, the printed part was separated from the excess powders to obtain the final 3D-printed part.

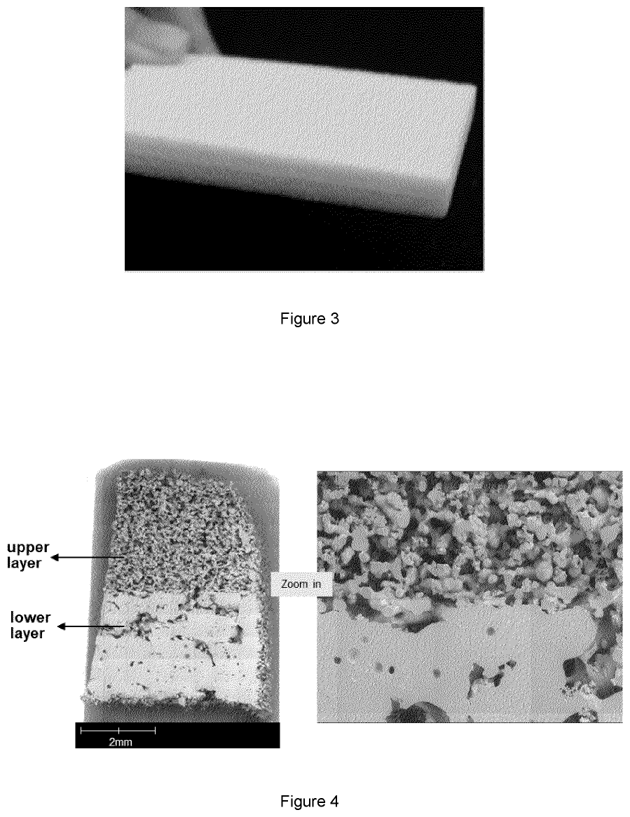

Hardness and rebound resilience of the upper layer and lower layer of the 3D-printed part were summarized in table 3. Picture of 3D-printed part of example 3 was shown in FIG. 3. SEM images of 3D-printed part of example 3 were shown in FIG. 4.

TABLE 3

| | | example | |
|---|---|---|---|
| | | 3 | |
| | | Upper layer | Lower layer |
| components | TPU powders (wt. %) | 99.5 | 99.5 |
| | N20 (wt. %) | 0.5 | 0.5 |
| Printing | Part bed T (° C.) | 65 | 65 |
| parameters | Feed T (° C.) | 40 | 40 |
| | Piston T (° C.) | 50 | 50 |
| | Cylinder T (° C.) | 50 | 50 |
| | Laser power density (mJ/mm²) | 23 | 59 |
| | Scan count | 6 | 2 |
| | Layer thickness (μm) | 180 | 180 |
| | Roller speed (mm/s) | 7.62 | 7.62 |
| Properties | Hardness (Shore A) | 18 | 52 |
| | Rebound resilience (%) | 47 | 54 |

As can be seen, 3D-printed parts comprising multiple areas having different properties were successfully prepared even by using the same material.

### Example 4: 3D Printed Part with Multiple Areas

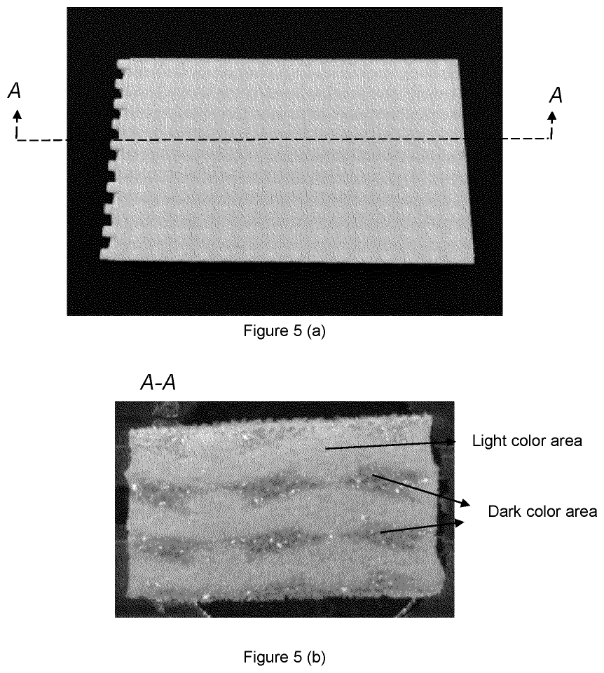

In Example 4, 3D-printed part with multiple areas, i.e., light color area and dark color area as shown in FIG. 5 (b) was prepared. The TPU powders obtained in example 1 were used in example 4. The powder composition in example 4 was prepared by blending the powders of the component as shown in table 4. The blending experiment was carried out on the HTS-5 High speed mixer from Dongguan Huanxin Machinery Co., Ltd. The powders were mixed under 1400 rpm for 60 seconds to obtain the powder composition.

The resulted powder composition was printed by HT251 Selective Laser Sintering 3D printer to prepare the 3D-printed part with different areas. For a typical printing process, the powder composition was loaded in the feed chamber of the printer. Detailed printing parameters were listed in the table 4.

Post-treatment process: Once the printing process was completed and the printed part was cooled, the build chamber was removed from the printer and transferred to a cleaning station, the printed part was separated from the excess powders to obtain the final 3D-printed part.

Picture of 3D-printed part of example 4 was shown in FIG. 5 (a). FIG. 5 (b) showed a micrograph of part of the section of the printing part depicted in FIG. 5 (a) in according with section line A-A.

TABLE 4

| | | example | |
|---|---|---|---|
| | | 4 | |
| | | Light color | Dark color |
| | | area | area |
| components | TPU powders (wt. %) | 99.5 | 99.5 |
| | N20 (wt. %) | 0.5 | 0.5 |
| Printing | Part bed T (° C.) | 65 | 65 |
| parameters | Feed T (° C.) | 40 | 40 |
| | Piston T (° C.) | 50 | 50 |
| | Cylinder T (° C.) | 50 | 50 |
| | Laser power density (mJ/mm²) | 59 | 23 |
| | Scan count | 2 | 6 |
| | Layer thickness (μm) | 180 | 180 |
| | Roller speed (mm/s) | 7.62 | 7.62 |

As can be seen, 3D-printed part comprising multiple areas was successfully prepared even by using the same material.

1.-20. (canceled)

21. Thermoplastic elastomer (TPE) powders, wherein the average particle size D50 of the TPE powders is in the range from 10 μm to 1 mm and at least one of average sphericity A and average sphericity B of TPE powders is no more than 0.6, wherein
$$Sphericity A = Source area of volume equivalent sphere of powder / Surface area of powder ,$$
$$and$$
$$Sphericity B = Radius of volume equivalent sphere of powder / Radius of circumscribed sphere of powder .$$

22. The TPE powders according to claim 21, wherein at least one of the average sphericity A and average sphericity B of TPE powders is in the range from 0.6 to 0.05.

23. The TPE powders according to claim 21, wherein the average particle size D50 of the TPE powders is in the range from 20 to 800 μm.

24. The TPE powders according to claim 21, wherein the bulk density of the TPE powders is in the range from 0.15 to 0.45 g/cm³.

25. The TPE powders according to claim 21, wherein the TPE is selected from thermoplastic polyurethane elastomer, thermoplastic co-polyester elastomer, thermoplastic polystyrene elastomer, polyether block amide, thermoplastic vulcanate, thermoplastic polyolefin, and combinations thereof.

26. A process of preparing the TPE powders according to claim 21, which comprises pulverizing a foamed TPE material.

27. The process according to claim 26, wherein the temperature of the foamed TPE material during the pulverization is lower than the Tg of the TPE material by at least 20° C.

28. The process according to claim 26, wherein the foamed TPE material is treated with liquid nitrogen before or during the pulverization.

29. The process according to claim 26, wherein the foamed TPE material has an average pore size in the range from 20 to 800 μm.

30. A powder composition comprising TPE powders as defined in claim 21 and at least one auxiliary agent.

31. A process of preparing the powder composition according to claim 30, which comprises adding the at least one auxiliary agent before, during and/or after the pulverization of the foamed TPE material.

32. A method of preparing 3D molding by layer-by-layer process, wherein the method comprises selectively bonding the TPE powders as defined in claim 21.

33. The method according to claim 32, wherein the 3D molding comprises n areas having at least one different property, wherein n is 2 or more.

34. The method according to claim 33, wherein the property is selected from density, Shore A hardness and rebound resilience and combination thereof, or selected from density, Young's modulus, tensile strength, elongation at break, rebound resilience, Shore A hardness and combination thereof.

35. The method according to claim 33, wherein the 3D molding comprises n areas having at least one different property and two areas of them meet at least one of following conditions:
(i) the density of said two areas differs by at least 0.05 g/cm³;
(ii) the rebound resilience of said two areas differs by at least 0.5%;
(iii) the Shore A hardness difference between said two areas is at least 5.

36. The method according to claim 32, wherein the selectively bonding comprises selective laser sintering, selective inhibition of the bonding of powders, multi jet fusion, high speed sintering, 3D printing, or a microwave process.

37. The method according to claim 33, wherein the n areas having at least one different property are formed via adjusting process parameters.

38. The method according to claim 37, wherein the n areas have different densities and printing parameters meet the following conditions:
(iv) the laser power density for forming the area having higher density is higher than that for forming the area having lower density,
and/or
the n areas have different rebound resilience and printing parameters meet the following condition:
(v) the laser power density for forming the area having higher rebound resilience is higher than that for forming the area having lower rebound resilience.

39. The method according to claim 33, wherein the n areas having at least one different property are formed from the same material.

40. A 3D molding obtained from the TPE powders according to claim 21.
